(19) United States
(12) Patent Application Publication
(10) Pub. No.: US 2003/0221184 A1
(43) Pub. Date: Nov. 27, 2003

(54) Template-based application development system

(76) Inventors: Atul Narayan Gunjal, Pune (IN); Abhijeet Ashok Pendharkar, Pune (IN)

Correspondence Address: NOTARO AND MICHALOS, 100 DUTCH HILL ROAD, SUITE 110, ORANGEBURG, NY, 10962-2100, US

(21) Appl. No.: 10/154,144

(22) Filed: May 22, 2002

(51) Int. Cl. G06F 9/44; G06F 9/45; G06F 15/00

(52) U.S. Cl. 717/118; 717/104; 717/108; 717/114; 717/116; 715/513; 717/148

(57) ABSTRACT

A system and method is provided defining a standard software application development framework that can be customized and linked to building blocks by various utilities and project layers, to implement standard business rules in an assembled code. Application developers can set programming standards through a template. By setting these standards, application developers use the system and method to define the naming convention, appearance of the code, reserve places for the comments, and ensure that specific types of code appear at a predefined locations in the code. The template is used while assembling the code.

### FIELD AND BACKGROUND OF THE INVENTION

The present invention relates in general to object oriented development of an application, and in particular to a JAVA program assembling system for assisting in constructing business application programs in the JAVA language.

Traditionally, business application programs used in business computers have been composed of such basic processes as the input, processing, and output of data records. For example, a loan application process is composed of inputting applicant's demographic information and loan data with input and display such as a keyboard and monitor, processing data records in memory, organizing data records into data files, and printing data records to an output such as a printer. As part of the basic processes that are involved with business application programs, various types of data records are transferred.

In conventional business application programs, code for the aforementioned processing steps are written in text form, for example, in the C or BASIC language, or in table form with various types of database tools. Simple languages such as C and BASIC are insufficient to meet the changing needs of businesses. Another form of application development is needed to ensure quality standards while improving productivity.

Patents are known which disclose different types of software development systems. For example, U.S. Pat. No. 6,237,135 discloses a development system for creating and maintaining JAVA beans components. A user may generate a JAVA bean component by invoking a wizard-based interface that implements methodology for automatically generating and managing the bean. The wizard is also used to guide the user into specifying information about the bean such as the name of the bean, the package it will be in, and the class it extends from. The properties of the JAVA been may then be managed accordingly via visual design tools. However, this system lacks a template for assigning a programming standard, a validation system and library rules, a business rule editor, and XML support.

U.S. Pat. No. 6,249,905 teaches the implementation of a computerized accounting system using object-oriented programming, which permits construction of user-defined business frameworks without modifying or recompiling the program code because reused components are added or deleted into and from the framework. A graphical user interface enables a user to interact with the system to accomplish tasks, including designing and constructing the business framework. The user can also specify changes in business rules or track business rules within the framework. The patent relates to the implementation of a computerized accounting system rather than the development of a JAVA application, and fails to teach a validation utility or a program specification builder, among other features.

U.S. Pat. No. 6,134,706 teaches a method for developing a software system using object oriented technology and a framework. An object oriented technology, such as JAVA, provides a class as a software template for objects comprised of data and methods. Frameworks provide a way of grouping multiple objects together to perform some function. Frameworks also provide a way of capturing a reusable relationship between objects, so that the objects do not have to be reassembled in the same relationship every time they are needed.

According to the method of U.S. Pat. No. 6,134,706, a plurality of business objects are organized in a tree structure and represent an organizational structure or framework of business objects. The framework allows the modeling of businesses with a multiple level organizational structure. But, user-interface validation of code, a program specification builder for defining classes, variables, and methods, and a business rule editor for linking business rules to JAVA beans are not provided.

U.S. Pat. No. 6,341,369 discloses a method and apparatus for applying and managing business rules used by an object-oriented application (e.g., JAVA application) in a data processing system. The application comprises objects and control points located within the objects, wherein the control point is activated upon execution of the objects to make a business rule decision. The business rules are classified via the control points and a classification system, to correspond to varying business situations so that when one is looking for business rules that are relevant to a particular business decision, the right set of rules may be found. The disclosed method and apparatus do not teach business rules associated with JAVA beans in the development of a JAVA application.

U.S. Pat. No. 6,330,711 discloses a method and apparatus providing a data processing system for managing rules in a program in a JAVA operating system. In particular JAVA classes containing business rules or logic may be modified, so that the framework of predefined classes or objects incorporated within those predefined classes may also be modified. An object is modified to create a new “dippable” object, which is an object with modifications that allow it to accept additional behavior in the form of a “dip” or class with an interface. A dip is an interface that has a new business rule. When the “dip” is added to the “dippable object,” a new business rule is added to an original object within an original class. However, the patent does not disclose a system for developing JAVA applications and does not use a business rule editor for linking business rules with business objects.

U.S. Pat. No. 5,991,534 teaches a method and apparatus for editing a software component for use in application development. A component class is obtained and the properties of the component are determined. An editor is obtained that modifies the properties of the component. A JAVA bean is one example of a software component for use in application development that may be modified. A component such as a JAVA bean may be configured by implementing the modified property. The patent does not teach a validation utility or the application of business rules to application development.

Clearly, improvements to object-oriented programming are still needed.

### SUMMARY OF THE INVENTION

It is an object of the present invention to provide a system and method for improving object-oriented application development productivity.

In particular, it is an object of the present invention to allow application developers to set programming standards through a template. By setting these standards, the application developers define the naming convention, appearance of the code, reserve places for the comments, and ensure that specific types of code appear at a predefined locations in the code. The template is used while assembling the code.

It is a further object of the present invention to provide a system and method for customizing a programming standard that can be used in a variety of application development scenarios.

It is yet another object of the invention to provide an object-oriented application development system with the ability to define commonly required field validation rules and link them to the HTML screens or Java screens, prompt users to enter business specifications, allow users to specify linkages between the front end and a database and help develop session beans, presentation beans and Java Server Pages.

It is a still further object of the invention to provide a system that allows users to define queries for accessing an application database, to define business rules in XML, and enable users to refer the routines from Java language libraries while generating code for session beans. The system also should allow users to represent business logic in the Java language, check the correctness of the assembled code, and assist users to validate the functionality of the assembled session beans.

It is a further object to provide a system in which a user interface is provided for allowing a user to implement various tools in achieving the goals of the invention.

In accordance with the invention, a software application development system is provided in which application developers can set programming standards through a customizable template. In setting these standards, the application developer defines a standard framework that can be customized and linked to building blocks by various utilities and project layers, to implement standard business rules in an assembled code.

A software development application layer according to the invention has a master layer, a utilities layer and a software project layer. The master layer includes a template assigner utility, a java script validation utility and a global variable utility. The utilities layers has several utility functions for application development, including a code check configuration utility, a program specification builder, a class builder, a code generator, a virtual configuration utility, a business rule editor, a JAR creator, a compiler, a JAVA server page builder, a test JAVA server page, and XML/XSL generator, a binary large object (BLOB) wizard and a presentation bean generator. The application development layer is composed of a software project layer, templates, JAVA classes, a JAVA server page and an enterprise JAVA bean.

The application development method herein permits creation and deployment of JAVA applications in various formats. Preferred formats include enterprise JAVA beans and servelet formats.

The steps taken to develop an application are generally divided into two primary parts. In the first part, an application developer: defines templates for classes, methods, program specifications and documentation; checks whether commonly required validation routines are present in the library, or repository, and if not, develops new routines; and defines naming rules to be observed by other developers of the application. In the second part, the application code is assembled by: using an HTML editor to define front end user interactions, if needed; setting commonly required rules for the project; developing the program specification; linking the commonly required front end validation with objects displayed on an HTML screen; building the session bean class; linking session bean member variables to HTML control objects; generating codes for a session bean and a JAVAServer Page; generating an XSL sheet; and generating documentation for the generated code.

Building the session bean class includes defining member variables and member methods, such as local variables, passed parameter details, return values, exception handling, data access details and return type, for a class, testing the method developed using a test JAVAServer page and generating a session bean code based on a provided template.

The system and method for JAVA application development provide easy creation of programs by even inexperienced developers using templates and structured wizards to guide the developers, for seamless interaction with the system.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a graphical representation of a system for executing the application development program according to the invention;

FIG. 2 is a diagram of a database used with the application development software of the invention;

FIG. 3 is a graphical representation of the components of the application development layer of the database in FIG. 2;

FIG. 4A is a flow chart illustrating a method for using the template assigner utility of FIG. 3 to construct a JAVA session bean;

FIG. 4B is a flow chart illustrating a method for using the template assigner utility of FIG. 3 to construct a JAVA presentation bean;

FIG. 5 is a flow chart diagram of a method for defining commonly required field validation rules and linking them to HTML screens or Java screens;

FIG. 6 is a flow chart of method for defining global variables;

FIG. 7 is a method for setting nomenclature conventions for classes, variables, and methods; and

FIG. 8 is a method for providing specification details about a class;

FIG. 9 is a method for configuring method return types, parameters, and exceptions;

FIG. 10 is a method for defining and linking business evaluation criteria;

FIG. 11 is a method for packaging classes;

FIG. 12 is a method for compiling classes;

FIG. 13 is a method for forming binary large objects for user interface HTML and Java controls;

FIG. 14 is a method for verifying correctness of a Java class method; and

FIG. 15 is a method for generating XML and XSL with regard to HTML content.

### DESCRIPTION OF THE PREFERRED EMBODIMENTS

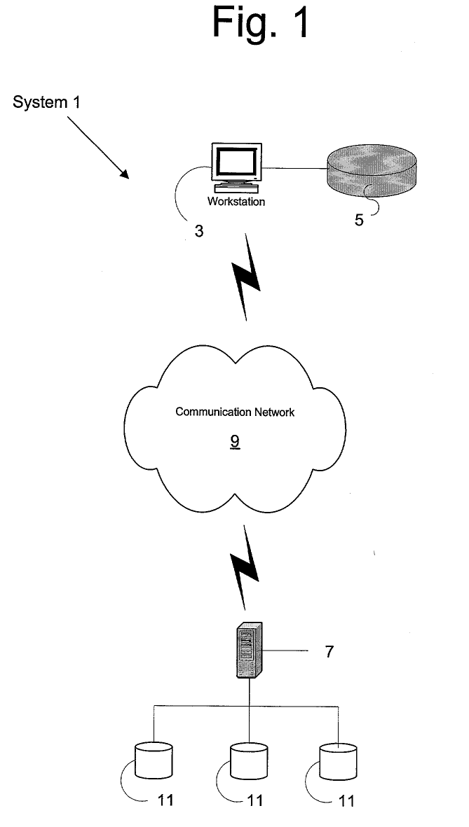

Referring now to the drawings, in which like reference numerals are used to refer to the same or similar elements, FIG. 1 shows a system 1 for implementing the present invention. The system 1 comprises a remote user or client computer 3, in the form of a computing device having a user interface. The client 3 contains a database 5, for storing applications and information. The client computer 3 may connect to the server 7 via a communication network 9. The communication network 9 can include direct, hard wired connections, or be a distributed network, like the Internet. The communication network 9 may use wireless connections too. The server 7 has one or more repositories 11 containing tools, objects, and other reusable software, as well as a catalog of information in metadata format.

The client 3 is preferably a computer, such as a PC or MAC, capable of processing and storing data. The client 3 includes a processor, a first storage device, or RAM, a second storage device, or hard drive, output, input, and a communication device. The communication device is preferably either a modem or a network interface card (“NIC”), and most preferably, a NIC, although other communication protocols can be used to transmit information.

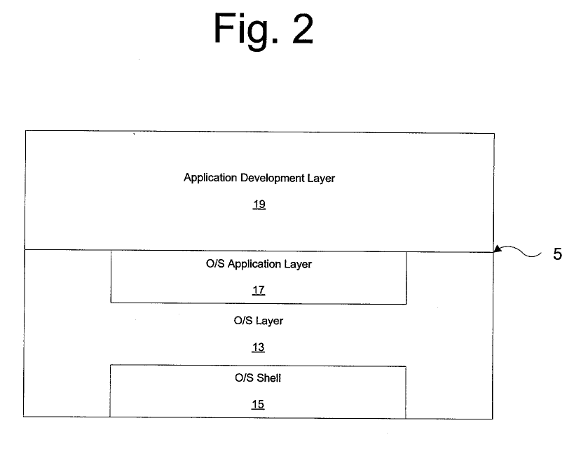

As more clearly shown in FIG. 2, the database 5 comprises various layers of software, including an operating system 13, an operating system shell 15, an operating system application layer 17, and an application development layer 19. The operating system components run client 3, while the application development layer 19 contains visual development utilities for application development. The operating system 13 is preferably Windows NT, but may also be any other operating system that supports application development in the JAVA programming language. The operating system 13 preferably has an application layer 17, that includes necessary applications such as a text editor or internet browser.

The server 7, similar to client 3, also contains a processor, RAM, hard drive, input and output devices, and a communication device. However, the server 7 processor is preferably more powerful than a standard client 3 processor, because it must be capable of handling multiple requests from several clients 3 and/or multi-tasking.

Furthermore, the server 7 preferably contains a plurality of repositories 11 for scalability, which are databases that contain reusable software and tools, and also store and manage information. In the system 1, a repository 11 is populated with multiple classes of objects. An object is a software bundle of related variables and methods for modeling real world applications such as business applications. Classes are the blueprints that define the variables and method common to all objects of a certain kind. Also, a repository 11 contains a tool for each class of object, which is used to display, navigate and manipulate the objects.

The repository 11 is preferably a relational database, such as a SQL server database, for storing information in the form of metadata. Metadata is information that describes reusable objects, such as software, and is analogous to the cards in a library card catalogue containing the location, author, subject, and title of books. In object oriented programming languages, metadata contains information about software data such as for example, class name, identity and location, graphical user interface (GUI) information, class constructors and methods, and dependencies such as resource files, e.g., uniform resource locators (URL) of files. For each object in the repository 11, there are corresponding metadata. The client 3 can identify an object of interest via descriptive metadata from objects, and then use a tool within the repository 11 to display, navigate and manipulate the object of interest.

Accordingly, the various software applications in the application development layer 19 may be organized and encoded into metadata by a metadata converter, and the resulting metadata may be stored in a relational database of one of a plurality of repositories 11. Once the hardware for the system is in place, the software development applications in the visual application development layer 19 may be accessed with the help of the metadata stored in the repository 11 of the server 7.

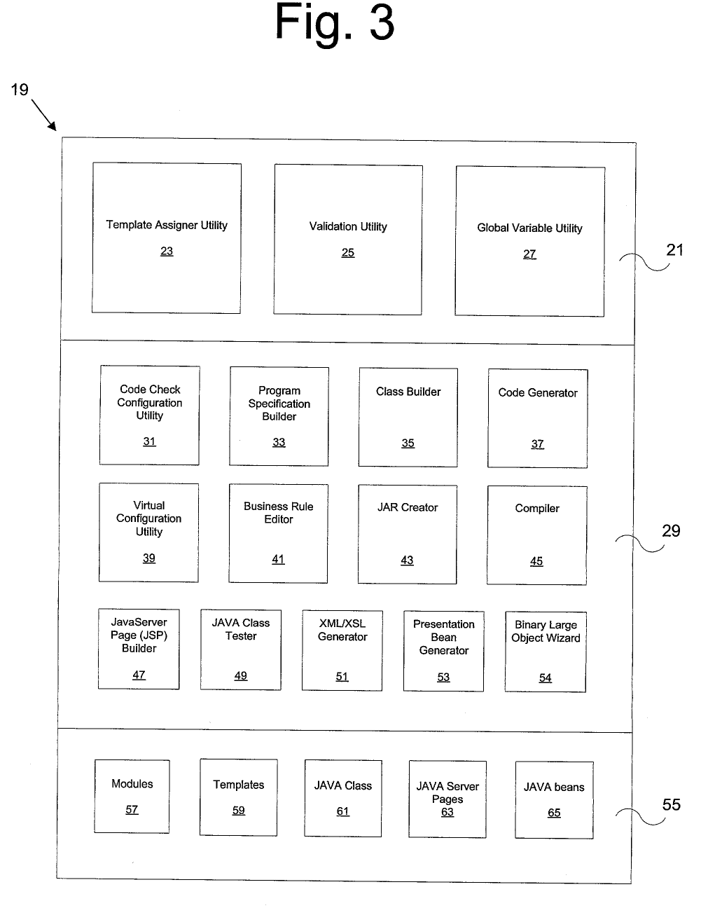

FIG. 3 illustrates an application development layer 19, which contains a master layer 21, comprised of a template assigner utility 23, a java script validation utility 25, and Global Variable 27. The application development layer 19 also contains a utilities layer 29 for object oriented application development. The utilities layer 29 has a code check configuration utility 31, a program specification builder 33, a class builder 35, a code generator 37, a virtual configuration utility 39, a business rule editor 41, a JAR creator 43, a compiler 45, a JAVA server page builder 47, a test JAVA server page 49, an XML/XSL Generator 51, a presentation bean generator 53 and a binary large object (BLOB) wizard 54. Finally, the application development layer 19 contains a software project layer 55 for adding various types of projects such as modules 57, templates 59, Java class 61, Java Server Page 63, and Enterprise Java bean (EJB) 65.

Template assigner utility 23 allows a user to define a new template or link an existing template with a building block (session bean, presentation bean, etc.) and then assemble the code for the building block. When a user has defined a class of a session bean and wants to create code for the class, which meets the standard set by the organization, then he can create the code using the template assigner utility 23. A user may customize the development of a template or framework for his program with the template assigner utility 23, thereby defining a programming standard.

For example, a template created with the template assigner utility 23 may define a naming convention, appearance of a code, or assurance that specific types of code appear at predefined locations in the overall code. After the template is defined, JAVA beans may be developed with the programming standards defined in the template and the assistance of an application database and a user interface. A JAVA bean is a reusable software component created with the JAVA program language and can be as simple as a button element for a graphical interface or as complex as a fully functional database viewer.

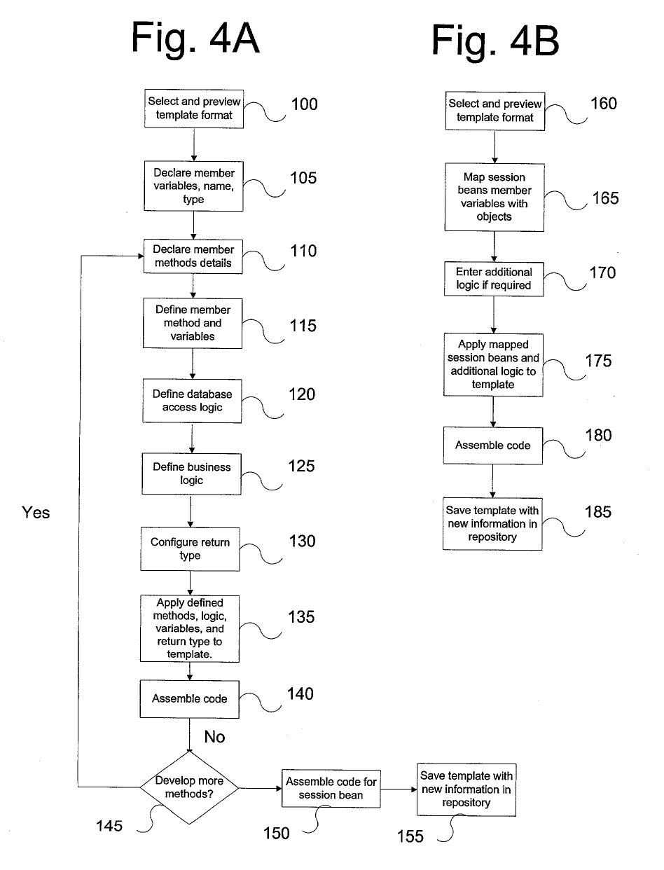

A method for using the template assigner utility 23 is exemplified in FIG. 4A, with one type of JAVA bean, called a session bean. A session bean is a software component which performs work for a client 3 on a server 7, executing business tasks for example, inside the server 7 rather than inside the client 3. The template assigner utility 23 allows a remote user at client 3 to define programming templates to be used for a session bean.

The remote user, operating from client 3, selects the template format, and can preview the template 100, if required. The user can set member variables and methods 105, 110. The user must then declare member method details and define member method business logic and local variables 115. Then, database access logic and business logic are defined 120, 125, respectively. A return type is subsequently configured 130. The user then applies the template to the defined information such as member methods and variables, database access logic and business logic 135.

The user assembles a code 140 for the defined method. After assembling the code, the user has the option of developing more methods 145, or assembling the code for the session bean 150. If the session bean code is created 150, the user can optionally save the applied template as a new template 155 in a repository 11. The new template is preferably accompanied by the encoding of metadata by a metadata converter for describing the new template.

A presentation bean can similarly be constructed by selecting a template format 160, mapping session bean member variables with objects using HTML 165, adding additional logic as needed 170, applying member variables from session beans to the template 175, assembling the code 180, and saving the new template 185 in a repository 11, as shown in FIG. 4B.

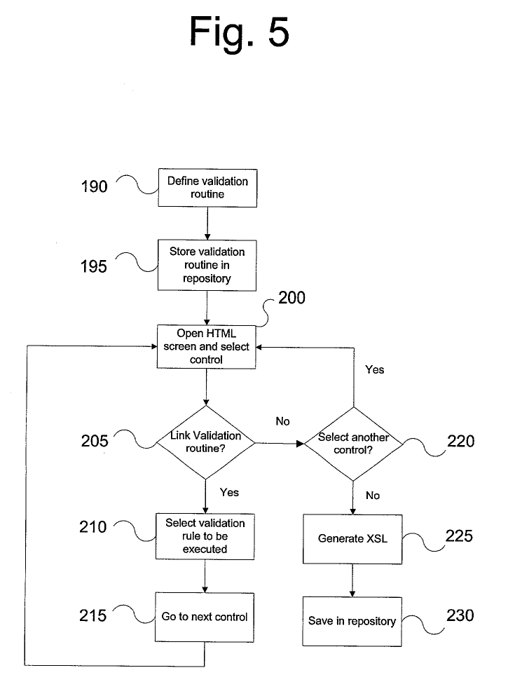

FIG. 5 shows a method for using the validation utility 25, which defines validations integrated through a user interface. A user at client 3 can define a particular validation with regard to commonly used controls on an HTML screen, such as a field for entering details. For example, validations for a text type object can require input text that is numeric only, or containing an e-mail address that is presented in a particular format. Validations are provided in JAVAscript format, and are stored in a repository 11. The validations may be directly linked to a user interface of an application.

First, the remote user at client 3 must define a validation routine 190 and save the validation routine 195, along with the appropriate encoded metadata, in a repository 11. The user opens an HTML screen and selects a control on the HTML screen 200. The user then decides whether to link validation to the selected control 205. If the validation will be linked, the user must select a validation rule to be executed 210. The user can then select a new control 215 and repeat the process of linking validations to controls 200-215. Once the user is done linking validations and chooses not to select another control 220, the utility 25 inserts the necessary code in a generated XSL 225. The generated XSL is saved 230 in the repository 11.

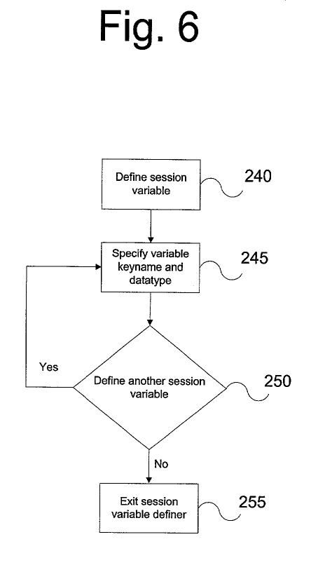

The global variable utility 27 allows a user at client 3 to define global variables, which can transfer data amongst themselves by reference to JavaServer Pages. More particularly, a user can define variables and then refer to these variables in a JavaServer Pages editor. A global variable also allows a user to define information that is passed from one HTML page to another. As displayed in FIG. 6, a user at client 3 opens a session variable using an editor, and can then define a session variable 240. The user then specifies a variable keyname and its data type 245. Once complete, the user can either choose to define other session variables 250 or can exit the editor 255.

The several functions of the utilities layer 29 will now be described.

Code check configuration utility 31 is provided to ensure that classes, variables, and methods follow a particular name convention by allowing a user to define naming standards for these classes, variables, and methods. The code check configuration utility 31 helps a user of client 3 ensure that nomenclature standards are followed in a project while developing code for session beans, presentation beans and JavaServer pages (JSP). As an example, the code check configuration utility 31 can be used to mandate that the method name of the class should be prefixed with “elx”. The prefix is added automatically when a user defines a method for a session bean. The code checker utility 31 verifies that the naming standards are followed. In case of non-compliance with the convention, the code checker utility 31 prompts users with a warning message. For example, if a class name does not start with “elx”, then the code checker will display a warning message such as, “class name must begin with elx.”

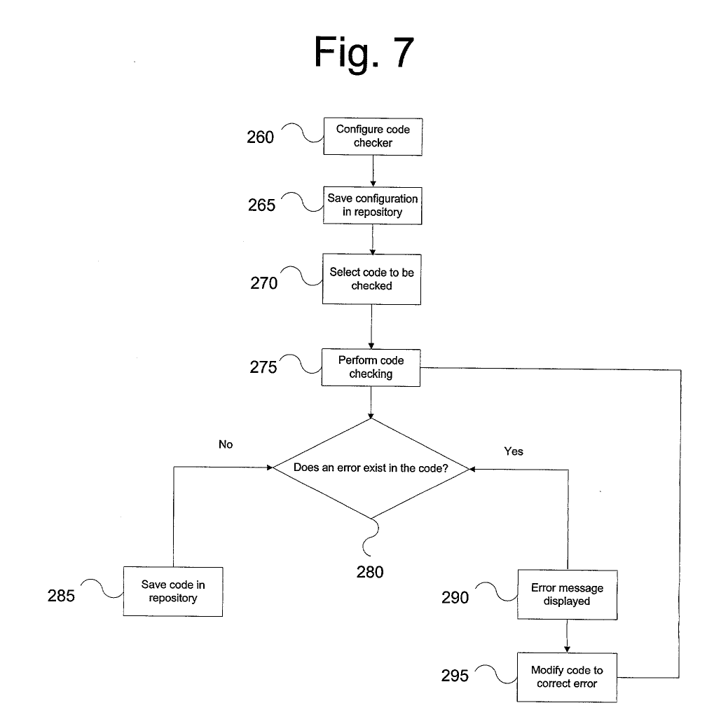

As illustrated in FIG. 7, the code checker utility 31 is first configured 260, such as to check naming conventions. The code checker configuration is saved 265 in the repository 11. The code being checked is then selected 270 at some time after the configuration has been saved 265. The utility performs the code checking 275. If no error exists 280, the code is saved 285 in a repository 11. If an error is detected 280, however, the utility displays an error message 290 and the user must correct the error 295. Following the correction, the code is checked again 275. If no error exists, the code is then saved 285 in the repository, or the notice of error and correction process is repeated until the code is correct.

A wizard-based program specification builder 33 is provided in the utility layer 29 to assist a user at client 3 by providing details about program classes, variables, and methods in a user-defined format. After the user has selected a template to define a programming standard, the properties of the program specification are defined. Upon completion of the specification, the specification can be printed for review or reference.

The user, for example, can use the specification builder 33 to define a naming convention to be used for variables, which can be saved in a repository 11. Classes and methods can also be added to the program specification after being constructed by a class builder 35. A class defines the implementation of a particular kind of object; it is a programming unit in object-oriented programs consisting of data and a range of operations. A method is a function that is defined in a class.

Class builder 35 is used to construct classes. The class builder 35 provides application developers using client 3 with a method for defining member variable(s) and member methods of the classes as well. Both standard JAVA data types or custom data types can be defined. The return type of the methods, method parameters, exceptions thrown by the method and the local variables in the method can all be defined using the class builder 35.

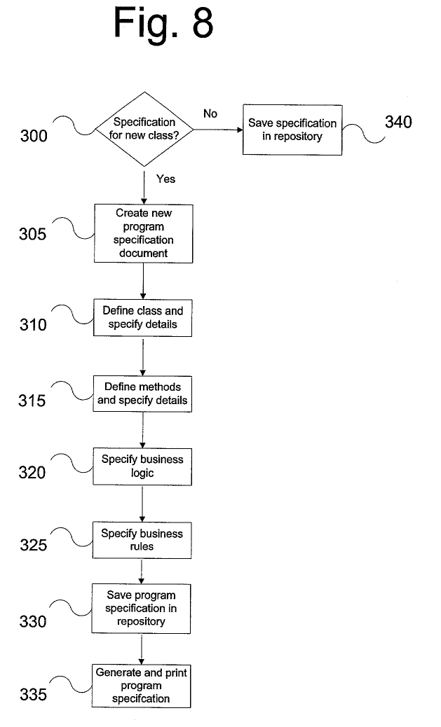

An exemplary method of using the program specification builder 33 to create a program specification for a new class is shown in FIG. 8. As a preliminary step to using the program specification builder 33, the user must define a naming convention to be used for member variables of a class. Then the user must choose whether he is writing a specification for a new class 300. If not, the specification can be saved 340 in a repository 11, in XML format.

If however, a specification for a new class is being written, a user must choose to create a new program specification document 305 within the program specification builder 33.

The user then defines a class 310, and specifies its class details, including variables, in accordance with the naming convention defined and saved in a repository by the code check configuration utility 31. The details specified 310 include the variable name, data type, default value, and scope. While defining class details 310, the user can specify type class/interface, class name, extends (e.g., object, vector), implements (e.g., session beans, entity beans), modifiers (e.g., public or protected), imports such as JAVA libraries, and remarks.

Then, member methods are defined 315 by providing details about method signature, parameter, type, name, and return value. A user can make other program specifications such as building business logic 320 by referring to JAVA library functions. The user can build business rules 325 using arithmetic and logical operators and expressions. Once all specifications are made, the user can save 330 the entire program specification in a repository 11, and generate and print 335 the program specification.

After a method is added, a virtual configuration utility 39 is used for configuring method return types, parameters and exceptions thrown by method. Once the configuration is completed, a presentation layer of JAVA beans and JAVAServer pages may be generated. The virtual configuration utility 39 can be used to generate a database access layer of session beans consisting of various DML operations on the database. The virtual configuration utility 39 is used by the system to generate a program specification document.

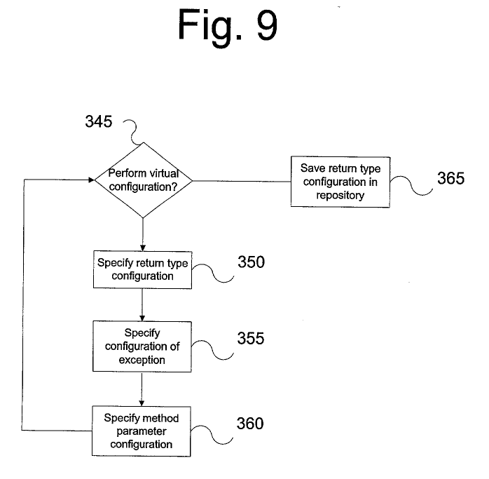

As shown in FIG. 9, if virtual configuration will be performed 345, a return type configuration must be specified 350. If the return type is a vector or hash table, then a value that the return type will contain at a particular position must be identified. Then, the configuration for an exception to be thrown by a method is specified 355. Finally, the method parameter configuration is specified 360. If the parameter is a vector or hash table, then the values that the parameter will contain at a particular position must be identified. If a virtual configuration is not desired, the return type configuration may be saved 365 in XML format in the repository 11.

Business rule editor 41 is used to define evaluation criteria in a JAVA application. Business rule editor 41 is a utility for linking a business rule to a business object such as a JAVA session bean. For instance, a user can define a “credit checking” rule with the business rule editor 41, where the attributes of a person are assessed to determine whether the person exceeds the minimum credit parameters, and whether a credit score based on the person's attributes is adequate.

Each business rule has a unique name. A business rule can have one or more conditions, which can in turn be combined with logic operators. Each condition has a field name, which can be column name of the application database or a class variable name, among other names, linked to another field name using an arithmetic or logical operator. The business rules are stored in XML file format in a repository 11 for rapid and easy reference and editing at a later time. The business rules are referred to when generating code. During execution of the code, the business rule is retrieved and passed to a utilities engine, which executes the business rule.

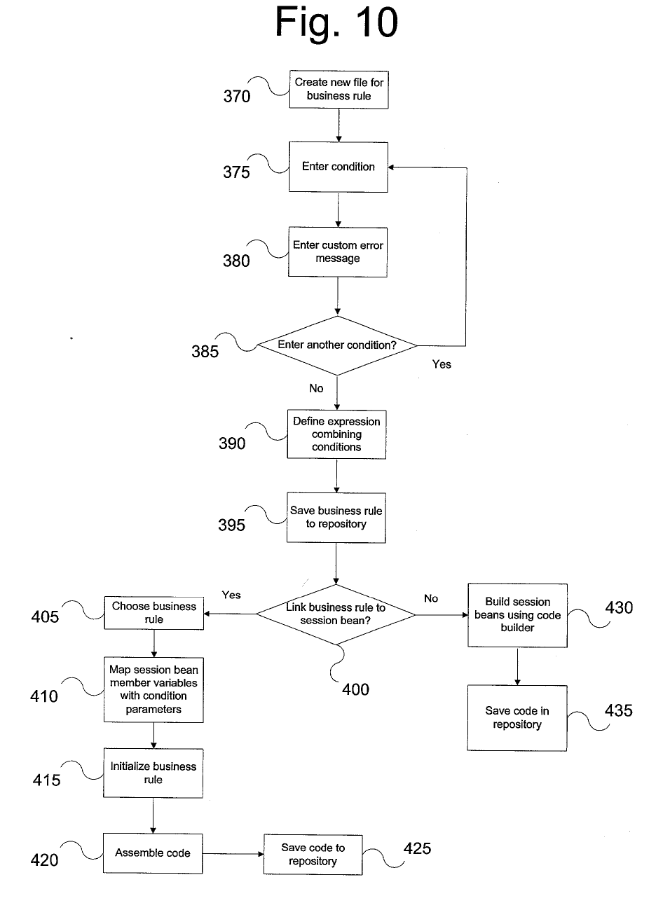

A method of using the business rule editor 41 is depicted in FIG. 10. First, a new file is created 370 for the business rule. Then, a condition is entered 375 by specifying criteria that is to be evaluated. A user may specify an error message 380 for displaying if the particular condition fails when tested. After all of the conditions have been defined for the rule 385, an expression is defined 390 by combining conditions using logical operators. The completed business rule is then saved 395 in a repository 11.

If a user subsequently wants to build a session bean and integrate the business rule for dictating the behavior of the session bean 400, the user may simply choose the business rule 405 from the repository 11 via base-level tools within the repository 11 that allow display, navigation and manipulation of the saved business rule. Member variables of the session bean are mapped with the condition parameters of the business rule 410. Then, the business rule is initialized 415, the code for the session bean is assembled 420, and the code is saved 425 in a repository 11.

Alternatively, the business rule does not have to be linked to a session bean 400. Instead, a session bean is built 430 using the code generator 37. The code is still saved 435 in repository 11.

Several other smaller, commonly used utilities are included in the application development layer 19 for creation of JAVA applications.

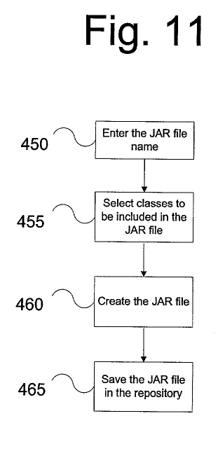

JAR creator 43 is provided for use combining one or more JAVA beans in one file for web based application server deployment, as demonstrated in FIG. 11. As seen, the a file name is entered 450 for the JAR package. Then, the classes to include in the JAR file are selected 455. The JAR file is automatically created with the packaged classes 460, and the JAR file are saved 465 in repository 11.

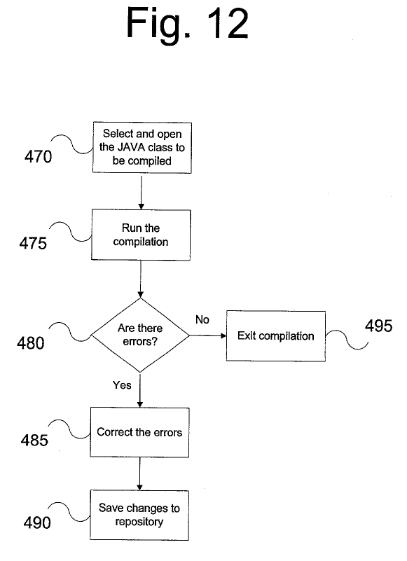

FIG. 12 shows a method for compiling classes using a compiler 45 of the present invention. First, a JAVA class to be compiled is selected and opened 470. Then, the source code of the class is translated into an object during compilation 475. The compiler 45 checks the compiled object for errors 480. If there are errors, the compilation errors are rectified 485, such as by a user. Then, changes are saved 490 in repository 11, and the compilation 475 is run again, followed by error check 480. If no errors are detected 480, the compiler 45 is exited 495.

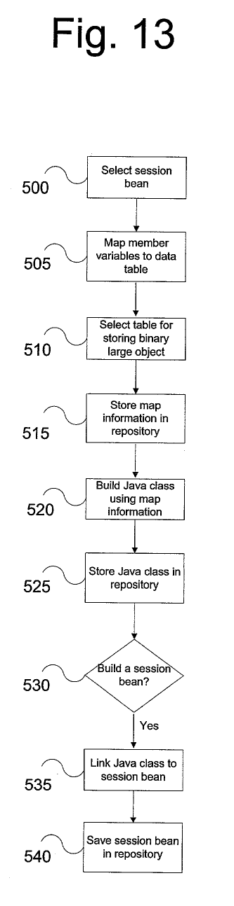

A binary large object (“BLOB”) wizard 54 is included in the application development system in utilities layer 29. The BLOB wizard 54 is a utility that allows the creation of binary large objects for user interface HTML controls or JAVA beans. A method for implementing the BLOB wizard is shown in FIG. 13.

Using the BLOB wizard 54, HTML controls or JAVA beans are converted to binary data, mapped, and stored in a distribution table on an application database. The BLOB wizard 54 builds a Java class which stores the binary large object in a distribution table. The distribution table comprises two columns. These columns are “unique key id” and the “BLOB column”. The BLOB wizard 54 then builds another Java class and takes the data from the distribution table and distributes it across to the various destination tables and columns designated by mapping.

As seen in FIG. 13, a session bean that is to be converted to binary data is selected 500. The session bean member variables are mapped 505 to a distribution table on an application database. The binary large object is then stored 510 in the distribution table on an application database. The map information is stored 515 in repository 11. The BLOB utility builds a JAVA class 520 using only the map information stored in the repository 11. The resulting JAVA class is then stored 525 in repository 11 as well. The created JAVA class can be linked to the session bean after the session bean is built 530, 535. The session bean is then saved 540 in repository 11.

A JAVA class tester 49 links one or more methods from a JAVA class 61 to a JAVAServer page template, generating a JAVAServer page 63 which displays the results of the method, thereby verifying correctness of the method.

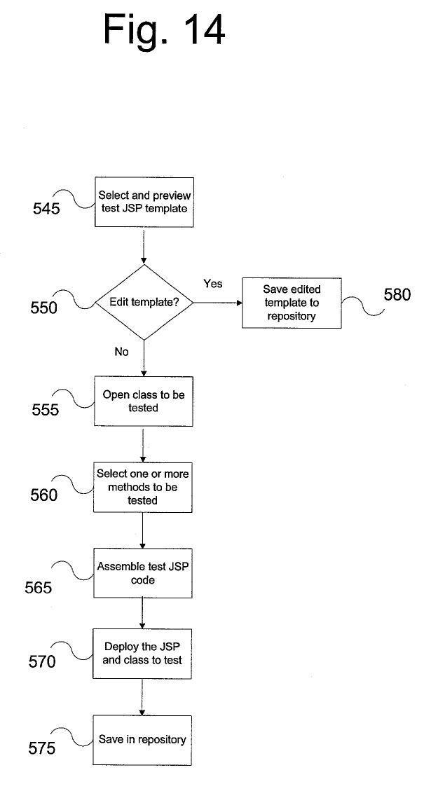

A method for using the JAVA Class Tester 49 is illustrated by FIG. 14. A test JAVAServer page template is selected and previewed 545 for determining whether the template needs to be edited 550. If the user edits the template, the new template must be saved 580 in repository 11. When the selected template is satisfactory, the class being tested is opened 555, and one or more methods to test are selected 560. The test JAVAServer page code is assembled 565 and the JAVAServer page with the class for testing is deployed 570. The JSP code is then saved 575 in repository 11.

XML and XSL can be used to separate content from the design of HTML. XSL can be generated from HTML defined by a user and the contents of the corresponding XML, which is a metalanguage used to create the HTML.

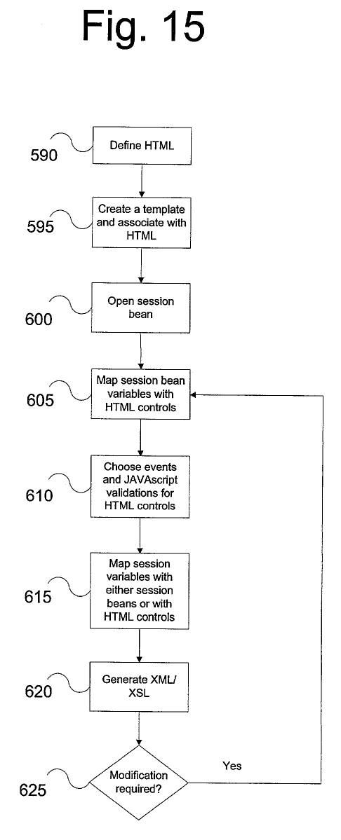

XSL can be created by XML/XSL generator 51 as demonstrated in FIG. 15. First, HTML is defined 590 and associated with a newly created template 595. A session bean is opened 600, and then the session bean variables are mapped with HTML controls 605. Events and Javascript validations for HTML controls are selected 610. Session variables are mapped 615 with either session bean variables or with HTML controls. XML and XSL are then generated 620. The XML file is generated 620 on the fly. If a modification is required 625, the session bean variables can be mapped again with the HTML controls 605 so that XML and XSL can be regenerated 610-620.

The software project layer 55 contains the necessary elements, or building blocks, for an application. The modules 57 provide the basic building blocks and always form the root node of the hierarchy of these building blocks. The templates, JAVA classes, JAVA beans, and JSPs are all sibling nodes and child nodes of a root node.

As needed, the modules 57, templates 59, JAVA classes 61, JSPs 63 and JAVA beans 65 are first created using the utilities from the utility layer 29 and/or retrieved from the repository 11 to create applications which conform to the rules set by the developer using the application development layer 19.

The template-based application development described herein provides a unique JAVA program assembly system. As described, templates are created for classes, class methods, JAVA server pages for testing components, program specifications and even program documentation.

The steps taken to develop an application are generally divided into two primary parts. In the first part, an application developer: defines templates 59 for classes 61, methods, program specifications and documentation using the template assigner utility 23; checks whether commonly required validation routines are present in the library, or repository, and if not, develops new routines using the validation utility 25; and defines naming rules to be observed by other developers of the application using the global variable utility 27.

In the second part, the application code is assembled using the several utilities in the utility layer 29. The different operations which can be done to assemble application code include: using an HTML editor to define front end user interactions, if needed; setting commonly required rules for the project using business rule editor 41; developing the program specification using specification builder 33; linking the commonly required front end validation with objects displayed on an HTML screen; building the session bean class; linking session bean member variables to HTML control objects; generating codes for a session bean and a JAVAServer Page; mapping a generated XSL sheet; and generating documentation for the generated code.

Building the session bean class includes defining member variables and member methods, such as local variables, passed parameter details, return values, exception handling, data access details and return type, for a class, testing the method developed using a test JAVAServer page and generating a session bean code based on a provided template.

While a specific embodiment of the invention has been shown and described in detail to illustrate the application of the principles of the invention, it will be understood that the invention may be embodied otherwise without departing from such principles.

What is claimed is:

1. A JAVA application development system for productively developing a business rule operated and object-oriented application, comprising;
at least one object-oriented building block;
a customizable template for integrating the at least one object-oriented building block;
a business rule utility for incorporating business rules into said at least one object-oriented building blocks;
a code generator utility for applying said object-oriented building blocks to said template;
a compiler utility for assembling code that includes said template, said business rules, and said object-oriented building blocks.

2. A JAVA application development system according to claim 1, further comprising a code check utility for verifying correctness of code assembled with the compiler utility.

3. A JAVA application development system according to claim 2, further comprising a test utility for validating functionality of code assembled with the compiler utility.

4. A JAVA application development system according to claim 1, further comprising a visual user interface facilitating remote user access to said system.

5. A JAVA application development system according to claim 1, wherein the at least one object-oriented building block comprises a template, a module, a JAVA class, a JAVAServer page and a JAVA bean.

6. A method for developing a JAVA application, comprising:
defining templates for classes, methods, program specifications and documentation;
providing validation routines in a library;
defining naming rules for the classes and methods;
assembling application code by steps comprising: using an HTML editor to define front end user interactions, setting commonly required rules for the application code, developing a program specification, linking validation routines with objects displayed on an HTML screen, building a session bean class using the class template, linking session bean member variables to at least one HTML control object, generating the application code from the session bean and a JAVAServer Page, mapping a generated XSL sheet, and generating documentation for the generated code.

7. A method according to claim 6, wherein building a session bean class comprises defining member variables for a JAVA class, defining member methods for the JAVA class, testing the defined member methods, and generating a session bean code based on the defined templates.

8. A method for developing a software application comprising:
providing at least one object-oriented building block;
providing an application template;
associating the application template with the at least one object oriented building blocks;
implementing business rules into the building blocks;
validating the application template, associated at least one building block and implemented business rules; and
assembling code from the validated application template.

9. The method of claim 8, further comprising generating a program specification from the application template.

10. The method of claim 8, wherein the at least one object-oriented building block comprises a module, a template, a JAVA class, a JAVAServer page, and a JAVA bean.

11. The method of claim 8, further comprising providing a utilities layer having at least one utility for creating the at least one object-oriented building block.

12. The method of claim 11, further comprising using the at least one utility to create an object-oriented building block selected from the group consisting of a module, a template, a JAVA class, a JAVAServer page, and a JAVA bean.

13. An object-oriented software application development system, comprising an application development layer for operating on a computer, the application development layer comprising:
a master application layer having a template assigner, a validation utility and a global variable utility;
a software project layer containing at least one building block selected from the group consisting of a module, a template, a JAVA bean, a JAVA class and a JAVAServer page; and
a utilities layer having at least one utility for creating another building block.

14. The system according to claim 13, wherein the at least one utility is selected from the group consisting of a program specification builder, a class builder, a code checker, a code generator, a virtual configuration utility, a business rule editor, a JAR creator, a compiler, a JAVAServer page builder, a JAVA class tester, an XML/XSL generator, a presentation bean generator and a BLOB wizard.
